(19) United States
(12) Patent Application Publication
(10) Pub. No.: US 2025/0205654 A1
(43) Pub. Date: Jun. 26, 2025

(54) Gas Separation Membranes

(71) Applicants: FUJIFILM MANUFACTURING EUROPE BV, Tilburg (NL); Fujifilm Corporation, Tokyo (JP)

(72) Inventors: Serguei Alexandrovich Starostine, Tilburg (NL); Erik Antonius Maria Vermeer, Tilburg (NL)

(21) Appl. No.: 18/850,213

(22) PCT Filed: Mar. 21, 2023
(86) PCT No.: PCT/EP2023/057168

§ 371 Date: Sep. 24, 2024

(30) Foreign Application Priority Data
Mar. 29, 2022 (GB) 2204428.3

(51) Int. Cl. B01D 69/12; B01D 53/22; B01D 67/00; B01D 69/02; B01D 69/10; B01D 71/02

(52) U.S. Cl. CPC B01D 69/1216; B01D 53/228; B01D 67/00791; B01D 69/02; B01D 69/107; B01D 71/025; B01D 71/027; B01D 2325/04

(57) ABSTRACT

A gas separation membrane comprising the following layers: (i) optionally a support layer; (ii) a discriminating layer; (iii) a further layer; and (iv) optionally a protective layer; wherein (a) the further layer (iii) and the discriminating layer (ii) each independently comprise groups of Formula (1): M-(O—)ₓ wherein: each M independently is a metal or metalloid atom; O is an oxygen atom; and each x independently has a value of at least 4; (b) the further layer (iii) comprises 1.5 to 10 atomic % of M of Formula (1) groups, wherein M is as hereinbefore defined; and (c) the discriminating layer (ii) comprises more than 10 atomic % of M of Formula (1) groups, wherein M is as hereinbefore defined.

This invention relates to gas separation membranes (GSMs) and to their preparation and use.

Gas separation membranes typically comprise a support (to provide mechanical strength) and a discriminating layer to distinguish between the gases to be separated. Often a protective layer is included on top of the discriminating layer in order to protect the discriminating layer from mechanical damage, e.g. during membrane handling and use. Damage to the discriminating layer can have undesirable consequences such as significantly reducing the selectivity of the GSM.

Typically protective layers comprise a polysiloxane and are formed on the discriminating layer by a wet chemical coating process.

While protective layers comprising a polysiloxane are useful for shielding the discriminating layer from damage, they also significantly reduce the gas-permeance of the GSM. There is a need for GSMs comprising both a protective layer and good gas permeance.

According to a first aspect of the present invention there is provided a gas separation membrane comprising the following layers:
(i) optionally a support layer;
(ii) a discriminating layer;
(iii) a further layer; and
(iv) optionally a protective layer;
wherein
(a) the further layer (iii) and the discriminating layer (ii) each independently comprise groups of Formula (1):

M-(O—)ₓ Formula (1)
wherein:
each M independently is a metal or metalloid atom;
O is an oxygen atom; and
each x independently has a value of at least 4;
(b) the further layer (iii) comprises 1.5 to 10 atomic % of M of Formula (1) groups, wherein M is as hereinbefore defined; and
(c) the discriminating layer (ii) comprises more than 10 atomic % of M of Formula (1) groups, wherein M is as hereinbefore defined.

In this specification, the term “comprising” is to be interpreted as requiring the presence of the stated parts, steps or components, but does not exclude the presence of one or more additional parts, steps or components. Reference to an item by the indefinite article “a” or “an” does not exclude the possibility that more than one of the item(s) is present, unless the context clearly requires that there be one and only one of the items. The optional gutter layer (referred to below) is often abbreviated to “GL”, the discriminating layer (ii) is often abbreviated to “DL”, the further layer (iii) is sometimes abbreviated to “FL” and the optional protective layer (iv) is often abbreviated to “PL”.

In the present specification, the separation or discriminating layer (ii) indicates a layer having a separation selectivity. A layer having a separation selectivity indicates a layer in which a ratio (P_{CO2}/P_{CH4}) of a permeability coefficient (P_{CO2}) of carbon dioxide to a permeability coefficient (P_{CH4}) of methane, in a case where a membrane having a thickness of 0.05 to 30 μm is formed and pure gas of carbon dioxide (CO₂) and methane (CH₄) is supplied to the obtained membrane at a temperature of 40° C. by setting the total pressure of the gas supply side to 0.5 MPa, is 10 or greater. This in contrast to the further layer (ii) which is not gas separation selective and its selectivity is far below 10, even more preferred below 5.

### BRIEF DESCRIPTION OF THE DRAWINGS

In the accompanying drawings:

FIG. 1(a) is a schematic vertical sectional view of a GSM (10) according to the present invention comprising the optional support layer (1), the discriminating layer (ii) (2) and the further layer (iii) (3).

FIG. 1(b) is identical to FIG. 1(a) except that the GSM (10) further comprises a protective layer (iv) (4).

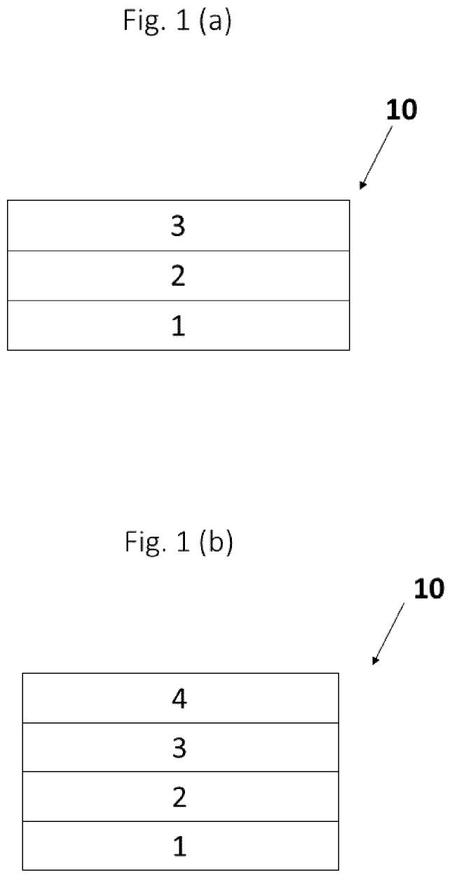

In both FIG. 1(a) and FIG. 1(b) the discriminating layer (ii) is characterised by high gas selectivity, thereby providing the main functionality of the GSM. The protective layer (iv) in FIG. 1(b) is intended to reduce possible mechanical damage to the discriminating layer (ii) and further layer (iii), e.g. during handling or use of the GSM. The protective layer (iv) typically has high gas permeance and durability, thereby protecting the DL from mechanical damage.

The optional support layer may be porous or non-porous.

Non-porous support layers (sometimes referred to as a ‘release layer’) are useful for providing a foundation for construction of the GSM. A non-porous support layer is also useful for providing the GSM with mechanical strength during storage and transportation and typically is peeled-off before the GSM is used (otherwise the support layer would be non-porous and this would prevent the flow of gas through the GSM).

The non-porous support layer optionally comprises a non-porous sheet and a (porous) gutter layer. In one embodiment, removal of the non-porous sheet from the GSM also removes the gutter layer. In another embodiment, removal of the non-porous sheet from the GSM does not remove the gutter layer and instead the gutter layer remains in contact with the discriminating layer even after the non-porous sheet has been removed from the GSM.

Examples of non-porous sheets which may be used as or in the support layer include polyethylene terephthalate sheet materials having a release coating on one or both sides, e.g. a silicone coating. Such sheet materials are available commercially from a number of suppliers, including Mitsui Chemicals Tohcello., Ltd, e.g. PET-O1-BM (ultra-low peeling strength), PET-O1-BU (low peeling strength), PET-O2-BU (medium peeling strength), PET-O3-BU (Medium-high peeling strength), PET-O3-B3 (high peeling strength) and PET-D13-BU (double-sided with one side medium to high peeling strength and the other with low peeling strength).

Porous support layers also provide GSMs with mechanical strength and, due to their porosity, do no need to be removed before the GSM is used. The porous support layer typically remains a permanent part of the GSM and provides mechanical strength even when the GSM is being used to separate or purify gases, thereby reducing the likelihood of the GSM being damaged when used at high pressures and/or temperatures. The permeation of other layers of the GSM (e.g. gutter layer or discriminating layer) into a porous support layer can provide a very strong bond between the support layer and the remainder of the GSM.

Optionally the support layer comprises both a non-porous layer and a porous layer, preferably with the porous layer in contact with the discriminating layer (ii).

Preferred porous support layers comprise, for example, woven and non-woven fabrics and combinations thereof.

The support layer may be constructed from, for example, any suitable polymer or natural fibre. Examples of such polymers include polysulfones, polyethersulfones, polyimides, polyetherimides, polyamides, polyamideimides, polyacrylonitrile, polycarbonates, polyesters, polyacrylates, cellulose acetate, polyethylene, polypropylene, polyvinylidenefluoride, polytetrafluoroethylene, poly(4-methyl 1-pentene) and especially polyacrylonitrile or polyethylene terephthalate (PET).

Many suitable materials for making the support layer are commercially available. Alternatively one may prepare the support layer using techniques generally known in the art for the preparation of such materials. In one embodiment one may prepare a porous support layer by curing curable components, e.g. in an analogous manner to that used to prepare membranes while ensuring the pores of the porous support layer are too large to discriminate between different gases.

Preferably layer (iii) is in contact with layer (ii). Typically layer (ii) is sandwiched between and in direct contact with layers (i) and (iii).

When layer (iv) is present, typically layer (iii) is sandwiched between and in direct contact with layers (ii) and (iv).

Optionally the support layer has been subjected to a corona discharge treatment, glow discharge treatment, flame treatment, ultraviolet light irradiation treatment or the like, e.g. for the purpose of improving its wettability and/or adhesiveness.

As porous support layer one may use, for example, an ultrafiltration membrane, e.g. a polysulfone ultrafiltration membrane, cellulosic ultrafiltration membrane, polytetrafluoroethylene ultrafiltration membrane, polyvinylidenefluoride ultrafiltration membrane and especially polyacrylonitrile ultrafiltration membrane. Asymmetric ultrafiltration membranes may also be used, including those comprising a porous polymer membrane (preferably of average thickness 10 to 150 μm, more preferably 20 to 100 μm) and optionally a woven or non-woven fabric support.

The support layer is preferably as thin as possible, provided that it provides the desired structural strength to the GSM.

Preferably the support layer comprises pores having an average diameter of 0.001 to 10 μm, preferably 0.01 to 1 μm (i.e. before the support layer has been converted into a gas separation membrane). Preferably the support layer comprises pores which, at the surface have an average diameter of 0.001 to 0.1 μm, preferably 0.005 to 0.05 μm. The average pore diameter may be determined by, for example, viewing the surface of the support layer by scanning electron microscopy (“SEM”) or by cutting through the support layer and measuring the diameter of the pores within the porous support layer, again by SEM, then calculating the average.

The porosity at the surface of the support layer may also be expressed as a % porosity i.e.

$$\% porosity = 100 \% \times \frac{( area of the surface which is missing due to pores )}{( total surface area )}$$

The areas required for the above calculation may be determined by inspecting the surface of the support layer by SEM before it has been converted into a gas separation membrane. Thus, in a preferred embodiment, the support layer has a % porosity >1%, more preferably >3%, especially >10%, more especially >20%.

Alternatively the porosity of the support layer may be characterised by measuring the N₂ gas flow rate through the support layer. Gas flow rate can be determined by any suitable technique, for example using a Porolux™ 1000 device, available from Porometer.com. Typically the Porolux™ 1000 is set at the maximum pressure (about 34 bar) and one measures the flow rate (L/min) of N₂ gas through the support layer under test. The N₂ flow rate through the support layer at a pressure of about 34 bar for an effective sample area of 2.69 cm² (effective diameter of 18.5 mm) is preferably >1 L/min, more preferably >5 L/min, especially >10 L/min, more especially >25 L/min. The higher of these flow rates are preferred because this reduces the likelihood of the gas flux of the resultant GSM being reduced by the support layer. The above pore sizes and porosities refer to the support layer before it has been converted into the GSM of the present invention.

The porosity of layer (i) (as a whole) may be expressed as a CO₂ gas permeance (units are m³(STP)/m²·s·kPa). When the GSM is intended for use in gas separation then layer (i) preferably has a CO₂ gas permeance of 5 to 150×10⁻⁵ m³(STP)/m²·s·kPa, more preferably of 5 to 100, most preferably of 7 to 70×10⁻⁵ m³(STP)/m²·s·kPa.

Layer (i) (when present as a whole) is not gas separation selective as compared to the discriminating layer (ii).

Layer (i) (as a whole) preferably has an average thickness of 20 to 500 μm, preferably 50 to 400 μm, especially 100 to 300 μm.

Typically the support layer (i) and the further layer (iii) are on opposite sides of discriminating layer (ii).

Preferably layer (i) further comprises a gutter layer (“GL”), preferably a gutter layer comprising a silicone or polysiloxane polymer. When layer (i) comprises a silicone or polysiloxane polymer gutter layer, the gutter layer is preferably located between the support layer and discriminating layer (ii).

The discriminating layer (ii) and the further layer (iii) may contain M from other sources, and not just from the groups of Formula (1). Thus the “total atomic % of M” (as distinct from the atomic % of M of Formula (1) groups referred to in claim 1) present in the discriminating layer (ii) and the further layer (iii) includes M from all sources, including but not limited to M from the groups of Formula (1). For example, the “total atomic % of M” present in the discriminating layer (ii) and the further layer (iii) includes M from other sources such as from one or more groups of Formula (2):

M-(O—)_{z} Formula (2)
wherein:
M is a metal or metalloid atom;
is an oxygen atom; and
z has a value of 1, 2 or 3.

Typically the DL (ii) and the further layer (iii) each independently comprise groups of Formula (1) and groups of Formula (2). Preferably, however, the DL (ii) comprises a greater mass of groups of Formula (1) than of groups of Formula (2). When the DL (ii) or the further layer (iii) contains groups of Formula (2), preferably M in the groups of Formula (1) is the same metal or metalloid atom as M in the groups of Formula (2) groups of that layer. M in the groups of Formula (1) and Formula (2) in the DL (ii) may be the same as or different to the M in the groups of Formula (1) and Formula (2) in the further layer (iii).

Preferably each M independently is silicon, titanium, zirconium or aluminium.

Preferably the DL comprises more than 10 atomic % and less than 50 atomic % of M of Formula (1) groups, especially 12 to 30 atomic % and more especially 13 to 27 atomic % of M of Formula (1) groups, wherein M is as hereinbefore defined.

Preferably the further layer (iii) comprises 2 to 9 atomic % of M of Formula (1) groups, more preferably 3 to 8 atomic % of M of Formula (1) groups, wherein M is as hereinbefore defined.

When the further layer (iii) comprises above 10 atomic % of M of Formula (1) groups the gas permeance of the GSM falls or drops significantly and the further layer becomes discriminating too. The further layer (iii) is therefore not separation selective or discriminating between gasses such as CO₂ and CH₄ as compared to the discriminating layer (ii). When the further layer (iii) comprises less than 1.5 atomic % of M of Formula (1) the permeance of the GSM falls significantly.

Preferably the further layer (iii) comprises 9 to 30.5 atomic % of M of Formula (2) groups and more especially 20 to 30 atomic % of M of Formula (2) groups, wherein M is as hereinbefore defined.

Preferably the total atomic % of M present in the further layer (iii) (i.e. M from all sources, e.g. from Formula (1) groups+Formula (2) groups) is from 13.5 to 35 atomic %, especially from 15 to 33 atomic % and more especially 16 to 32 atomic %.

Preferably the composition of the further layer (iii) is substantially constant throughout its depth. For example, the atomic % of M of Formula (1) groups present in the further layer (iii) varies by less than 25% (more preferably less than 10%, especially less than 5%) relative to the average atomic % of M in the further layer (iii) for at least 80% of the depth of the further layer (iii). As an example, if the average atomic % of M in the further layer (iii) is ‘X %’ then the atomic % of M in the further layer (iii) is preferably from 0.75X to 1.25X for at least 80% of the depth of the further layer (iii) (more preferably 0.9X to 1.1X, especially 0.95 to 1.05X).

The atomic % of M (e.g. derived from Formula (1) groups and from any Formula (2) groups etc.) in the further layer (iii) (and also in the DL (ii)) may be determined using surface analysis equipment, for example by X-ray photoelectron spectroscopy (XPS) (e.g. using GC-IB/XPS Gas cluster ion beam XPS). Such equipment may also be used to determine the atomic % of M at the top-surface and at different depths in and below the surface of the further layer (iii), and any other layers (e.g. the DL or GL, when present). A suitable piece of equipment for performing analysis to determine the atomic % of M in the various layers is the VersaProbe II XPS apparatus from Physical Electronics, Inc. (“ULVAC-PHI”). The ULVAC-PHI is preferably set up with monochromated Al K_{α} (1486.6 eV, 15 W25 KV 100 μmφ, raster size 300 μm×300 μm) X-ray source. For charge compensation, low energy electron and Ar ion may be flooded during measurement of the atomic % of M in the various layers. Ar gas cluster beam (5 kV, 20 nA, 2 mm×2 mm) may be used for depth profile analysis. From this analysis, the atomic % of M and any other elements present in the further layer (iii) (e.g. carbon and oxygen) may be measured. At the data point which has the highest atomic % of M, the atomic % of M in the further layer (iii) can be determined. This will include M from all sources such as groups of the Formula (1) or Formula (2) as defined above and the amount of M in each of these groups can be quantified separately. For example, when M is silicon, the atomic % of silicon in Si—(O—)₄ groups and Si—(O—)_{z} groups (wherein z is 1, 2 or 3) can be quantified by this method. In the spectrum of Si2p, the bonding energy at 102.6 eV is defined as being a group of Formula (2), whereas the bonding energy of 103.8 eV is defined as being a group of Formula (1), wherein Formula (1) and Formula (2) are as hereinbefore defined. The area ratio of Si2p at 102.6 eV and at 103.8 eV may be converted to an atomic ratio (atomic %) so that the total of the separated peak components area would correspond to the atomic % of Si.

In one embodiment, the further layer (iii) comprises a substantially constant value of 1.5 to 10 atomic % of M of Formula (1) groups throughout the depth of the further layer (iii). For example atomic % of M of Formula (1) groups present in the further layer (iii) varies by less than 25% relative to the average atomic % of M of Formula (1) groups throughout the depth of the further layer (iii). By building in the further layer (iii) composition with a substantially constant atomic % of Si of Si—(O—)₄ groups between 1.5 and 10% above the DL, the further layer (iii) can be considered not separation selective practically or discriminating between gasses such as for example CO₂ and CH₄ or gasses such as CO₂ and O₂ or between O₂ and N₂ or for example between H₂ and CH₄. Not gas separation selective means in this application that an engineer skilled in the art would not propose the further layer (iii) as source or embodiment for meaningful gas separation of CO₂ and CH₄ or gasses such as CO₂ and O₂ or between O₂ and N₂ or for example between H₂ and CH₄.

In another embodiment, the discriminating layer (ii) comprises a substantially constant value greater than 10 atomic % of M of Formula (1) groups throughout the depth of the discriminating layer (ii). For example total atomic % of M of Formula (1) groups present in the discriminating layer (ii) varies by less than 25% relative to the average atomic % of M of Formula (1) groups throughout the depth of the discriminating layer (ii).

The atomic % of M of Formula (1) groups, wherein M is as hereinbefore defined, is the atomic % of M present in the relevant layer in the form of groups of Formula (1). Similarly, the atomic % of M of Formula (2) groups, wherein M is as hereinbefore defined, is the atomic % of M present in the relevant layer in the form of groups of Formula (2).

In one embodiment the further layer (iii) is obtainable or obtained by a process comprising plasma treatment. A suitable plasma treatment process comprises plasma deposition, especially plasma deposition of compounds comprising M such that a further layer (iii) is formed comprising the groups of Formula (1) and optionally also the groups of Formula (2) (each as hereinbefore defined). Preferred plasma treatment processes for depositing M in the form of groups of Formula (1) onto layer (ii) and optionally also groups of Formula (2) (each as hereinbefore defined) onto layer (ii) are performed using precursors under atmospheric pressure in the absence of oxygen and/or air.

In another embodiment the discriminating layer (ii)) is obtainable or obtained by a process comprising plasma deposition of M in the form of groups of Formula (1) onto layer (i) and optionally also plasma deposition of groups of Formula (2) (each as hereinbefore defined) onto layer (i). A suitable plasma treatment process comprises plasma deposition, especially plasma deposition of compounds comprising M such that a discriminating layer (ii) is formed comprising the groups of Formula (1) and optionally also the groups of Formula (2) (each as hereinbefore defined).

In one embodiment, further layer (iii) is applied to discriminating layer (ii) by a plasma treatment process using a precursor compound which provides the groups of Formula (1) (as hereinbefore defined). A carrier gas may be used using noble gass(es) (e.g. argon or helium).

The plasma treatment process for applying layer (iii) to layer (ii) is preferably performed at an energy level in the range of 0.30 to 9.00 J/cm² (and using low pressure or even at (remote) atmospheric plasma treatment).

The plasma treatment process for applying layer (iii) to layer (ii) is preferably performed using a flow rate of argon in the range of 5 to 500 cm³(STP)/min, more preferably in a range of 50 to 200 cm³(STP)/min, and particularly preferably in a range of 80 to 120 cm³(STP)/min. The low pressure plasma treatment is preferably performed at a gas pressure in the range of 0.6 Pa to 100 Pa, more preferably in a range of 1 to 60 Pa, and particularly preferably in a range of 2 to 40 Pa.

When a silicon-containing precursor compound is used in the plasma treatment process this results in the deposition of the further layer (iii) onto layer (ii) as a silica-like top-surface comprising the groups of Formula (1) and usually also groups of Formula (2), both as hereinbefore defined.

The average thickness of further layer (iii) is typically in the range 1 to 1,500 nm, more preferably 5 to 1,000 nm and even more preferably 10 to 500 nm.

According to a second aspect of the present invention there is provided a process for forming a gas separation membrane according to the first aspect of the present invention comprising the steps of:
(a) applying the discriminating layer (ii) to the support layer (i) by a plasma treatment process; and
(b) applying further layer (iii) to the discriminating layer (ii) (the DL) by a plasma treatment process; and
optionally (c) applying a protective layer (iv) to the further layer (iii).

When the support layer (i) is or comprises a non-porous sheet the process according to the second aspect of the present invention optionally further comprises the step of removing the non-porous sheet from the gas separation membrane.

In a preferred embodiment, discriminating layer (ii) is applied to support layer (i) by a plasma treatment process, e.g. using a plasma treatment device. The preferred plasma treatment process for applying discriminating layer (ii) to support layer (i) comprises use of an atmospheric pressure glow discharge plasma for example as described in U.S. Pat. No. 10,427,111, page 40, line 4 to page 41, line 36, which is included herein by reference thereto. For example, support layer (i) may be exposed to an atmospheric pressure glow discharge plasma thereby forming discriminating layer (ii) thereon.

The plasma treatment process which may be used in step (a) and step (b) is preferably performed using a plasma treatment apparatus comprising a treatment space and a first electrode and a second electrode in the treatment space for generating an atmospheric pressure glow discharge plasma between the first and second electrode. The electrodes can be provided with a dielectric barrier in various arrangements. In one arrangement the dielectric barrier of at least one electrode is formed by a polymer film or inorganic dielectric. Such as polymer like polyethylene terephthalate (PET), polytetrafluoroethylene (PTFE) or polyethylene (PE) or ceramic such as silica or alumina, or combinations of these, also microporous dielectric materials attached to the electrodes can be used.

In a preferred embodiment, the further layer (iii) is applied to discriminating layer (ii) using atmospheric pressure glow discharge plasma (as plasma treatment process).

As mentioned above, preferably the atomic % of M of Formula (1) groups in the further layer (iii) is substantially constant throughout the depth of the further layer (iii). In order to achieve the substantially constant atomic % of M of Formula (1) groups in the further layer (iii), the manufacturing process for the further layer (iii) preferably differs from that used to make the DL in that precursors are used in the presence of noble and inert gasses in the absence of oxygen.

In step (b) the plasma treatment process preferably comprises generating an atmospheric pressure glow discharge plasma in a treatment space comprising layer (i) at an effective power density of 0.03 to 30 W/cm², preferably for less than 120 seconds. Preferably the treatment space is free from oxygen (e.g. the treatment space comprises an oxygen-free inert gas).

In step (a) the plasma treatment process preferably comprises generating an atmospheric pressure glow discharge plasma in a treatment space comprising layer (i) at an effective power density of 0.1 up to 30 W/cm², preferably for less than 60 seconds. Preferably in that case in step (a) the treatment space comprises an oxygen-rich atmosphere.

Thus it is preferred that both steps (a) and (b) comprise a plasma treatment process wherein step (b) is performed in an atmosphere free-from oxygen and step (a) is performed in an atmosphere comprising oxygen.

The plasma treatment process(es) can typically be performed using a precursor compound (especially an organosilicon compound). The preferred plasma treatment in step (b) uses a precursor compound. The precursor compound may be included in the treatment space and is preferably performed (in step (b)) at an energy of 0.1 to 10 J/cm².

In a preferred embodiment, the treatment space used in step (b) comprises an atmosphere free of air or free from oxygen and a power density of 0.1 to 10 J/cm² is used.

In a preferred embodiment, the plasma treatment process used in step (a) and/or step (b) comprises stabilization of an atmospheric pressure glow discharge plasma, e.g. according to any of the methods described in, for example, U.S. Pat. No. 6,774,569 and EP1383359.

In a preferred embodiment the plasma treatment process used in step (b) comprises exposing discriminating layer (ii) to an atmospheric pressure glow discharge plasma, wherein the plasma is stabilized by an inductance and capacitance (LC) matching network, for example as described in EP1917842.

In another embodiment, the further layer (iii) may be applied to layer (ii) (the DL) using a plasma treatment process performed in a low pressure plasma environment, e.g. as described in U.S. Pat. No. 10,427,111.

The plasma treatment apparatus used to perform the plasma treatment step(s) may, in a further embodiment, comprise a transport device for transporting layer (i) (the support layer) or layers (i)+(ii) combined, past the electrode. Also, the transport device may comprise a tensioning mechanism for keeping layer (i) or layers (i)+(ii) in close proximity to the electrode.

In one embodiment, the further layer (iii) is obtainable from one or more precursor compounds which may be included in the treatment space.

Precursor compounds which may be used to provide groups of Formula (1) (as hereinbefore defined) and optionally groups of Formula (2) (as hereinbefore defined) include TEOS (tetraethyl orthosilicate), HMDSO (hexamethyldisiloxane), TMOS (tetramethyl orthosilicate), TMCTS (1,3,5,7-tetramethylcyclotetrasiloxane), D4 OMCTS (octamethyl cyclotetrasiloxane), D5 (decamethylcyclopentasiloxane), D6 (dodecamethylcyclohexasiloxane), silane (SiH₄), bis(triethoxysilyl)ethane (BTESE), TPOT (tetrapropylorthotitanate), TEOT (titanium ethoxide), TTIP (titanium tetraisopropoxide) or ZTB (zirconium tetra-tert-butoxide).

A substantially uniform further layer (iii) may be prepared using the atmospheric pressure glow discharge equipment as described in EP1917842 using an inductance and capacitance (LC) matching network. In this embodiment the further layer (iii) preferably has an average thickness in the range 1 to 1,000 nm and even more preferred in the range from 10 to 500 nm.

Thus in a preferred embodiment of the process according to the second aspect of the present invention, step (a) comprises applying the discriminating layer (ii) to the support layer (i) by a plasma treatment process and step (b) comprises applying the further layer (iii) to the discriminating layer (ii) by a plasma treatment process.

The function of the discriminating layer (ii) is to discriminate between gases, separating a feed gas mixture into a permeate which passes through the GSM and a retentate which does not pass through the GSM. In order to discriminate between gasses the DL comprises more than 10 atomic % of M of Formula (1) groups, wherein M is as hereinbefore defined.

The permeate and retentate typically comprise the same gases as the feed gas mixture, but one is enriched in at least one of the gases present in the feed gas and the other is depleted in that same gas.

The average thickness of the discriminating layer (ii) is preferably in the range 1 nm to 2 μm, more preferably in the range 3 nm to 1 μm and especially in the range 5 to 200 nm.

Support layer (i) preferably comprises a porous support (e.g. made from any of the porous support materials described above) and a gutter layer (“GL”). The GL is preferably attached to the porous support (e.g. coated thereon). When the support layer (i) comprises a non-porous support (e.g. to provide mechanical strength during storage and transportation) the non-porous support is typically removed (e.g. peeled-off) before the GSM is used.

The GSM optionally comprises a protective layer (iv) which be made from analogous materials to those used to make the GL.

When the GSM does not contain a PL and/or support layer (i) it may still be used for gas separation or it may be sold as an item of commerce for customers to apply their own, bespoke PL, if they so wish. The optional GL and PL are permeable to gasses and typically have a low ability to discriminate between gases. The GL and PL, when present, preferably comprise a polymer resin, especially a polysiloxane. Preferred polysiloxane(s) present in or as the GL and/or PL are poly(dimethyl)siloxanes, e.g. a polymer comprising an —Si—(CH₃)₂—O— repeat unit.

The GL, when present, preferably has an average thickness in the range 50 to 2400 nm, preferably in the range 150 to 800 nm and especially in the range 200 to 650 nm.

The PL, when present, preferably has an average thickness in the range 10 to 10,000 nm, more preferably in the range 50 to 5,000 nm and especially in the range 100 to 3,000 nm.

Preferred GL and PL each independently comprise groups which are capable of bonding to a metal, for example by covalent bonding, ionic bonding and/or by hydrogen bonding, preferably by covalent bonding. The identity of such groups depends to some extent on the chemical composition of the GL/PL and the identity of the metal, but typically such groups are selected from epoxy groups, oxetane groups, carboxylic acid groups, amino groups, hydroxyl groups, vinyl groups, hydrogen groups and thiol groups. More preferably the GL and PL each independently comprise a polymer having carboxylic acid groups, epoxy groups or oxetane groups, vinyl groups, hydrogen groups, or a combination of two or more of such groups. Such a polymer may be formed on the support by a process comprising the curing of a radiation-curable or heat-curable composition, especially a curable (e.g. radiation-curable) composition comprising a polymerisable dialkylsiloxane. The latter option is useful for providing GLs and PLs comprising dialkylsiloxane groups, which are preferred.

The polymerisable dialkylsiloxane which may be present in the optional GL and PL is preferably a monomer comprising a dialkylsiloxane group or a polymerisable oligomer or polymer comprising dialkylsiloxane groups. For example, one may prepare the GL and/or PL from a radiation-curable composition comprising a partially crosslinked, radiation-curable polymer comprising dialkylsiloxane groups, as described in more detail below. Typical dialkylsiloxane groups are of the formula —{O—Si(CH₃)₂}n- wherein n is at least 1, e.g. 1 to 100. Poly(dialkylsiloxane) compounds having terminal vinyl groups are also available and these may be incorporated into the GL and/or PL by the curing process.

In one embodiment the GL is free from groups of formula Si—C₆H₅.

In one embodiment the PL is free from groups of formula Si—C₆H₅.

Irradiation of the radiation-curable composition (sometimes referred to as “curing” in this specification) to form the optional GL or PL may be performed using any source which provides the wavelength and intensity of radiation necessary to cause the radiation-curable composition to polymerise and thereby form the GL on the support layer or form the PL on further layer (iii). For example, electron beam, ultraviolet (UV), visible and/or infrared radiation may be used to irradiate (cure) the radiation-curable composition, with the appropriate radiation being selected to match the components of the composition.

The optional GL and optional PL are preferably each independently obtained from curing a curable composition comprising:
(1) 0.5 to 25 wt % of radiation-curable component(s), at least one of which comprises dialkylsiloxane groups,
(2) 0 to 5 wt % of a photo-initiator, and
(3) 70 to 99.5 wt % of inert solvent.

Preferably the curable composition used to prepare the GL/PL has a molar ratio of titanium:silicon of at least 0.0005, more preferably 0.001 to 0.1 and especially 0.003 to 0.03.

The radiation-curable component(s) of component (1) typically comprise at least one radiation-curable group. Radiation curable groups include ethylenically unsaturated groups (e.g. (meth)acrylic groups (e.g. CH₂═CR¹—C(O)— groups), especially (meth)acrylate groups (e.g. CH₂═CR¹—C(O)O— groups), (meth)acrylamide groups (e.g. CH₂═CR¹—C(O)NR¹— groups), wherein each R¹ independently is H or CH₃) and especially oxetane or epoxide groups (e.g. glycidyl and epoxycyclohexyl groups).

In addition to providing a smooth surface for the discriminating layer, the GL also provides the GSM with some additional mechanical strength, even when the GSM has been prepared from a non-porous sheet material which has been peeled-off after storage and transportation of the GSM. The amount of radiation-curable component(s) present in the curable composition used to prepare the optional GL and/or the optional PL (i.e. component (1)) is preferably 1 to 20 wt %, more preferably 2 to 15 wt %. In a preferred embodiment, component (1) of the curable composition used to prepare the optional GL and/or PL comprises a partially crosslinked, radiation-curable polymer comprising dialkylsiloxane groups.

The function of the inert solvent (3) is to provide compositions with a viscosity suitable for the particular method used to apply the curable composition to the support. For high speed application processes one will usually choose an inert solvent of low viscosity. Examples of suitable inert solvents are mentioned above in relation to preparation of the polymer sheet.

The amount of inert solvent (3) present in the curable composition used to prepare the optional GL and/or PL (i.e. component (3)) is preferably 70 to 99.5 wt %, more preferably 80 to 99 wt %, especially 90 to 98 wt %.

Inert solvents are not radiation-curable.

The compositions may contain other components, for example surfactants, surface tension modifiers, viscosity enhancing agents, biocides and/or other components capable of co-polymerisation with the other ingredients.

The gas separation membranes of the present invention may be packaged and supplied commercially to companies who assemble gas separation modules, e.g. for their own use or for onward sale.

According to a third aspect of the present invention there is provided a gas separation module comprising one or more gas separation membranes according to the first aspect of the present invention.

The gas separation modules of the present invention preferably further comprise a feed carrier and a permeate carrier, optionally wound onto a perforated tube.

Preferred gas separation modules include a spiral type module, a hollow fiber type module, a pleat type module, a tubular type module, and a plate and frame type module.

According to a fourth aspect of the present invention there is provided use of a gas separation membrane according to the first aspect of the present invention or a gas separation module according to the third aspect of the present invention for separating gases and/or for purifying a feed gas.

The gas separation membranes and modules of the present invention are particularly useful for the separation of a feed gas containing a target gas into a gas stream rich in the target gas and a gas stream depleted in the target gas. For example, a feed gas comprising polar and non-polar gases may be separated into a gas stream rich in polar gases and a gas stream depleted in polar gases. In many cases the membranes have a high permeability to polar gases, e.g. CO₂, H₂S, NH₃, SOₓ, and nitrogen oxides, especially NOx, relative to non-polar gases, e.g. alkanes, H₂, and N₂. Thus the polar gas is preferably CO₂, H₂S, NH₃, SOₓ, a nitrogen oxides or two or more thereof in combination. The non-polar gas is preferably N₂, H₂, an alkane or two or more thereof in combination.

Preferably the polar and non-polar gases are gaseous when at 25° C.

The target gas may be, for example, a gas which has value to the user of the module or element and which the user wishes to collect. Alternatively the target gas may be an undesirable gas, e.g. a pollutant or ‘greenhouse gas’, which the user wishes to separate from a gas stream in order to meet a product specification or to protect the environment.

The modules and GSMs of the present invention are particularly useful for purifying natural gas (a mixture which predominantly comprises methane) by removing polar gases (CO₂, H₂S); for purifying synthesis gas; and for removing CO₂ from hydrogen and from flue gases. Flue gases typically arise from fireplaces, ovens, furnaces, boilers, combustion engines and power plants. The composition of flue gases depend on what is being burned, but usually they contain mostly nitrogen (typically more than two-thirds) derived from air, carbon dioxide (CO₂) derived from combustion. Flue gases also contain a small percentage of pollutants such as particulate matter, carbon monoxide, nitrogen oxides and sulphur oxides. Recently the separation and capture of CO₂ has attracted attention in relation to environmental issues (global warming).

The modules and GSMs of the present invention are particularly useful for separating the following: a feed gas comprising CO₂ and N₂ into a gas stream richer in CO₂ than the feed gas and a gas stream poorer in CO₂ than the feed gas; a feed gas comprising CO₂ and CH₄ into a gas stream richer in CO₂ than the feed gas and a gas stream poorer in CO₂ than the feed gas; a feed gas comprising CO₂ and H₂ into a gas stream richer in CO₂ than the feed gas and a gas stream poorer in CO₂ than the feed gas, a feed gas comprising H₂S and CH₄ into a gas stream richer in H₂S than the feed gas and a gas stream poorer in H₂S than the feed gas; and a feed gas comprising H₂S and H₂ into a gas stream richer in H₂S than the feed gas and a gas stream poorer in H₂S than the feed gas.

The modules and GSMs of the present invention are particularly useful for separating ‘dirty’ a feed gas comprising a polar gas, a non-polar gas and a hydrocarbon containing at least two (e.g. 2 to 7) carbon atoms into a permeate gas and a retentate gas, one of which is enriched in the polar gas and the other of which is depleted in the polar gas.

The invention will now be illustrated by the following, non-limiting examples in which all parts and percentages are by weight unless specified otherwise.

### EXAMPLES

In these Examples the performance of the gas separation membranes was measured using a multi-layer structure comprising the gas separation membrane under test having the support layer (i) (when present) or Layer (ii) facing the 05TH100S sheet below, 05TH100S sheet and 42369 sheet having the general structure shown Table 1.

The 05TH100S sheet and 42369 sheet are described in more detail below.

TABLE 1
Multilayer structures comprising GSMs
Gas Separation Membrane under test

05TH100S sheet
42369 sheet

In the Examples, the feed gas used had the composition shown in Table 2 below:

TABLE 2

| | Components | | |
|---|---|---|---|
| Feed gas | CO₂ | CH₄ | n-C₄H₁₀ |
| vol % | 13.00 | 86.00 | 1.00 |

The performance properties of the gas separation membranes of the present invention and the Comparative GSMs were measured using the multilayer structure shown in Table 1 by the following techniques:

### (A) Permeance:

The feed gas having the composition described in Table 2 above was passed through the multilayer structure shown in Table 1 under test at 40° C. at a gas feed pressure of 6000 kPa. The flux of CO₂ and n-C₄H₁₀ and CH₄ through the multilayer structures shown in Table 1 was measured using a gas permeation cell with a measurement diameter of 2.0 cm.

The permeance (Qᵢ) of CO₂ and n-C₄H₁₀ and CH₄ was determined after 5 minutes continuous use of the multilayer structures shown in Table 1 (which comprise the GSM under test) using the following equation:

$${Q}_{i} = ( {θ}_{Perm} \cdot {X}_{Perm , i} ) / ( A \cdot ( {P}_{Feed} \cdot {X}_{Feed , l} - {P}_{Perm} \cdot {X}_{Perm , i} ) )$$

wherein:
Qᵢ=Permeance of the relevant gas (i.e. i is CO₂ or C₄H₁₀ or CH₄) (m³(STP)/m²·kPa·s);
θ_{Perm}=Permeate flow rate (m³(STP)/s);
X_{perm,i}=Volume fraction of the relevant gas in the permeate gas;
A=Membrane area (m²);
P_{Feed}=Feed gas pressure (kPa);
X_{Feed,i}=Volume fraction of the relevant gas in the feed gas;
P_{Perm}=Permeate gas pressure (kPa); and

STP is standard temperature and pressure, which is defined here as 25.0° C. and 1 atmosphere pressure (101.325 kPa).

The (Qᵢ) can be determined by 1 GPU=1×10⁻⁶ cm³(STP)/(s·cm²·cmHg).

The permeance of CO₂ above 150 GPU was evaluated as good and below or equal to 150 GPU was evaluated as comparative result and compared to the inventive examples as not good.

### (B) Selectivity

The selectivity (CO₂/C₄H₁₀ and CO₂/CH₄; αCO₂/C₄H₁₀ and αCO₂/CH₄) of each multilayer structure shown in Table 1 under test for the gas mixture described in Table 2 was calculated from QCO₂ and Qn-C₄H₁₀ calculated as described above based on following equations:

$$α {CO}_{2} / n - {C}_{4} {H}_{10} = {QCO}_{2} / Qn - {C}_{4} {H}_{10} ; \\ α {CO}_{2} / {CH}_{4} = {QCO}_{2} / {QCH}_{4}$$

wherein QCO₂, QCH₄ and Qn-C₄H₁₀ were determined by the method described in step (A) above.

An αCO₂/n-C₄H₁₀ value of 100 or higher was deemed to be acceptable and an αCO₂/n-C₄H₁₀ value of below 100 was deemed to be unacceptable.

An αCO₂/CH₄ value of 26 or higher was deemed to be good and an αCO₂/CH₄ value of below 15 was deemed to be unacceptable. For the αCO₂/CH₄ values between 26 and 15 it was evaluated acceptable.

### (C) Gutter Layer Thickness

The thickness of gutter layers was determined by cutting through the support layer (i) and measuring the thickness of the gutter layer from the sheet material outwards by SEM.

### (D)—the Atomic % of M of Formula (1) Groups

The atomic % of M of Formula (1) groups in the DLs and FLs was determined using the general method described above in the description using a X-ray photoelectron spectroscope using GC-IB/XPS Gas cluster ion beam XPS apparatus from Physical Electronics, Inc. (“ULVAC-PHI”). The ULVAC-PHI is set up with monochromated Al K_{α} (1486.6 eV, 15 W 25 KV 100 μmφ, raster size 300 μm×300 μm) X-ray source. For charge compensation, low energy electron and Ar ion may be flooded during measurement of the atomic % of M in the various layers. Ar gas cluster beam (5 kV, 20 nA, 2 mm×2 mm) is used for depth profile analysis.

### Preparation of the Gas Separation Membranes

The following materials were used to prepare the GSMs and multilayer structures:
PAN is a porous sheet material having an average thickness of 170-180 μm comprising a PET nonwoven support (140-150 μm thick) having a porous polyacrylonitrile layer. PAN was obtained from Microdyn-Nadir GmbH, Germany, under the trade name UA100T.
PET-O1-T is a non-porous polyethylene terepthalate sheet having a silicone-resin-based thin film of release agent on one side (from manufactured by Mitsui Chemicals Tohcello., Ltd.).
X-22-162C is a dual end reactive silicone having carboxylic acid reactive groups, a viscosity of 220 mm²/s and a reactive group equivalent weight of 2,300 g/mol, from Shin-Etsu Chemical Co., Ltd. (MWT 4,600) (I is an integer).

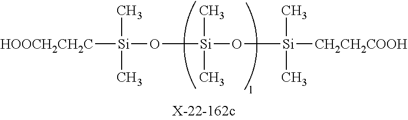

DBU is 1,8-diazabicyclo[5.4.0]undec-7-ene from Sigma Aldrich.
UV-9300 is SilForce™ UV-9300 from Momentive Performance Materials Holdings having an epoxy equivalent weight of 950 g/mole oxirane (MWT 9,000, determined by viscometry)) (m and n are integers).

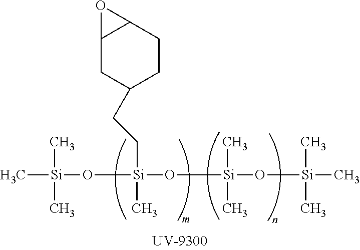

CAS: 67762-95-2
I0591 is 4-isopropyl-4′-methyldiphenyliodoniumtetrakis(pentafluorophenyl) borate (C₄₀H₁₈BF₂₀I) from Tokyo Chemical Industries N.V. (Belgium)

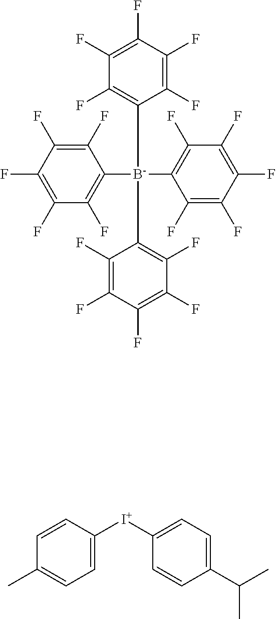 [SMILES: Fc1c(F)c(F)c([B-](c2c(F)c(F)c(F)c(F)c2F)(c2c(F)c(F)c(F)c(F)c2F)c2c(F)c(F)c(F)c(F)c2F)c(F)c1F ; Cc1ccc([I+]c2ccc(C(C)C)cc2)cc1]

Ti(OiPr)₄ is titanium (IV) isopropoxide from Dorf Ketal Chemicals (MWT 284). n-Heptane is n-heptane from Brenntag Nederland BV.
MEK is 2-butanone from Brenntag Nederland BV.
HMDSO is hexamethyl disiloxane (98%) supplied by Merck which is used a precursor for the further layer (iii).
05TH100S sheet is a sheet material from Hirose paper manufacturing (a wet-laid polyester non-woven/average thickness 100 μm/average weight 100 g/m²/average density 0.93 g/cm³).
42369 sheet is a porous sheet material from Guilford (a fabric made from polyethylene terephthalate and epoxy resin/average thickness of 0.3 mm/60 wpi (wales per 2.54 cm)/59 cpi (courses per 2.54 cm)).

### Preparation of Gas Separation Membranes

### Stage a) Preparation of a Partially Cured Polymer (“PCP Polymer”)

The components UV-9300, X-22-162C and DBU were dissolved in n-heptane in the amounts indicated in Table 3 and maintained at a temperature of 91° C. for 168 hours. The resultant polymer (PCP Polymer) had a Si content (meq/g polymer) of 12.2 and the resultant solution of PCP Polymer had a viscosity of 125 mPas at 25.0°

TABLE 3
Ingredients used to Prepare PCP Polymer

| Ingredient | Amount (w/w %) |
|---|---|
| UV-9300 (w/w %) | 46.395 |
| X-22-162C (w/w %) | 13.596 |
| DBU (w/w %) | 0.009 |
| n-Heptane (w/w %) | 40.000 |

### Stage b) Preparation of Curable Composition C

The solution of PCP Polymer arising from the Stage a) was cooled to 20° C. and diluted using n-heptane to give the PCP Polymer concentration indicated in Table 4 below. The solution was then filtered through a filter paper having a pore size of 2.7 μm. The photoinitiator (10591) and a metal complex (Ti(OiPr)₄) were then added in the amounts (wt/wt %) indicated in Table 4 to give Curable Composition C. The amount of Ti(OiPr)₄ present in Curable Composition C corresponded to 55.4 μmol of Ti(OiPr)₄ per gram of PCP Polymer. Also the molar ratio of metal:silicon in Curable Composition C was 0.0065.

TABLE 4
Ingredients of Curable Composition C

| Ingredient | Amount (wt/wt %) |
|---|---|
| PCP Polymer | 10.000 |
| I0591 | 0.105 |
| Ti(OiPr)₄ | 0.226 |
| DBU | 0.001 |
| MEK | 2.008 |
| n-Heptane | 87.660 |

Curable Composition C was used to prepare the gutter layer (“GL”) in Examples 1 to 4 and Comparative Examples CEx.1 to CEx.4. Additionally Curable Composition C was used to prepare the protective layer in Example 4 and Comparative Example CEx.4, (as described in more detail below).

Step i. Preparation of the Support Layers SL1 and SL2

Curable Composition C (prepared as described in stage b) above) was applied to PAN (a porous sheet material) by meniscus dip coating at a speed of 10 m/min was and then irradiated at an intensity of 16.8 kW/m (70%) using a Light Hammer LH10 from Fusion UV Systems fitted with a D-bulb to give support layer SL1 comprising PAN and a gutter layer of dry thickness 600 nm.

### SL2

Support layer SL2 was prepared in an identical manner to SL1 except that in place of PAN there was used PET-O1-T (a non-porous sheet material) SL2 comprised a gutter layer of dry thickness 600 nm.

Step ii. Applying a Discriminating Layer (ii) to the Support Layers SL1 and SL2 to Give SL1-DL1 and SL2-DL1

A discriminating layer was applied to each of the support layers SL1 and SL2 as follows:

The support layer (SL1 or SL2) was placed in the atmospheric plasma device described in EP1917842, FIG. 5. The discriminating layer was produced on the support layers (SL1 or SL2) by using the following conditions: the oxygen flow rate was set at 0.5 dm³ (STP)/min and the argon flow rate was set at 20 dm³ (STP)/min. The plasma treatment was performed at an input power of 1.75 J/cm² for 2 seconds. The above plasma treatment provided a composite of porous support SL1 and discriminating layer DL1 (SL1-DL1) and a composite of support SL2 and discriminating layer DL1 (SL2-DL1). The thickness of the discriminating layer DL1 in each case was 60 nm.

The atomic % of M of Formula (1) groups in the discriminating layer DL1 of SL1-DL1 and SL2-DL1 was determined by X-ray photoelectron spectroscopy using the method described in section (D) above and was found in each case to be greater than 10 atomic %.

### Example 1—Applying the Further Layer (iii) to Give Inventive Gas Separation Membrane GSM1

A sample of SL1-DL1 (consisting of a support layer (i) and discriminating layer obtained in step (ii) above) was exposed to an atmospheric pressure glow discharge (APG) plasma using precursor HMDSO. The device used for the exposure was as described in EP1917842. The precursor mass flow supplied via controlled evaporation unit was 1.0 g/hr HMDSO. The precursor vapours were diluted in (oxygen-free) argon process carrier gas. The flow of the process gas was 20 dm³ (STP)/min. The applied plasma power density was 0.15 W/cm² and the treatment time was 13 seconds in all cases. This gave gas separation membrane GSM1 according to the present invention.

The thickness of the further layer (iii) in GSM1 (i.e. SL1-DL1-FL1) was determined by cutting through GSM1 and measuring the thickness of the further layer (iii) using a scanning electron microscope. The average thickness of further layer FL1 was found to be 100 nm.

The atomic % of M of Formula (1) groups in the further layer FL1 in GSM1 was determined at depths of 10 nm and 20 nm by X-ray photoelectron spectroscopy using the method described in section (D) above and was found to be 2 atomic %.

### Example 2—Applying the Further Layer (iii) to Give Inventive Gas Separation Membrane GSM2

GSM 2 was prepared exactly as described above for GSM1 except that in place of SL1-DL1 there was used non-porous SL2-DL1.

The thickness of the further layer of GSM2 and the atomic % of M of Formula (1) groups in the further layer of GSM2 were identical to those in GSM1 (100 nm thickness and 2 atomic %).

### Example 3—Removing the Non-Porous Sheet from GSM2 to Give Gas Separation Membrane GSM3

The non-porous PET-O1-T sheet was peeled-off GSM2 to give GSM3. The thickness of the further layer of GSM3 and the atomic % of M of Formula (1) groups in the further layer of GSM3 were identical to those in GSM1 (100 nm thickness and 2 atomic %).

### Example 4—Preparation of Gas Separation Membrane GSM4 Having a Protective Laver

GSM4 was prepared by meniscus dip coating GSM1 in Curable Composition C at a speed of 10 m/min. The coating was then cured by irradiating at an intensity of 24 kW/m using a Light Hammer LH10 from Fusion UV Systems fitted with a D-bulb. The average thicknesses of the resultant protective layer in GSM4 was 2,400 nm, as measured by SEM.

### Comparative Examples CEx.1 to CEx.4—CGSM1 to CGSM4

Comparative gas separation membranes CGSM1 to CGSM4 were prepared in an identical manner to inventive GSM1 to GSM4 in Examples 1 to 4 respectively, except that in place forming layer (iii) by plasma treatment a polymer layer was applied to the discriminating layer by meniscus dip coating of Curable Composition C at a speed of 10 m/min. The coated discriminating layers were then cured by irradiating at an intensity of 24 kW/m using a Light Hammer LH10 from Fusion UV Systems fitted with a D-bulb to give comparative gas separation membranes CGSM1, CGSM2, CGSM3 and CGSM4 respectively, each having a polymer layer of average thickness 100 nm (as measured by SEM) instead of layer (iii) according to the present invention. In CGSM1, CGSM2, CGSM3 and CGSM4 the polymer layer used instead of layer (iii) had less than 1 atomic % of M of Formula (1) groups, wherein M is as hereinbefore defined.

The permeance and selectivity of the GSMs and comparative GSMs described above were measured by the techniques described above and the results are shown in Table 5 below:

TABLE 5
Summary of GSMs, Comparative GSMs and their properties

| | | | Further Layer (iii) | | PL Layer (iv) | | |
|---|---|---|---|---|---|---|---|
| | | DL layer (ii) | (% (averaged) | | (2,400 nm thick)/ | | |
| | | (% atomic | atomic of M of | | Protective layer | | |
| | | of M of | Formula (1) | | Atomic % of | | |
| | | Formula (1) | groups)/average | | M of Formula | Permeance | Selectivity |
| | GSM | groups | thickness (nm) | | (1) groups | [GPU] | CO₂/CH₄ |
| Ex. 1 | GSM1 | >10 | 2/100 | nm | — | 290 | 29 |
| Ex. 2 | GSM2 | >10 | 2/100 | nm | — | — | — |
| Ex. 3 | GSM3 | >10 | 2/100 | nm | — | 300 | 26 |
| Ex. 4 | GSM4 | >10 | 2/100 | nm | Yes/<1 | 270 | 32 |
| CEx. 1 | CGSM1 | >10 | <1/100 | nm | — | 100 | 31 |
| CEx. 2 | CGSM2 | >10 | <1/100 | nm | — | — | — |
| CEx. 3 | CGSM3 | >10 | <1/100 | nm | — | 105 | 27 |
| CEx. 4 | CGSM4 | >10 | <1/100 | nm | Yes/<1 | 95 | 33 |

Note:
GSM2 and Comparative CGSM2 comprised a non-porous sheet of PET-O1-T to provide mechanical strength during storage and transportation. This non-porous sheet was removed (peeled-off) to give GSM3 and CGSM3 respectively.

From Table 5 above it can be seen that GSM1, GSM3 and GSM4 according to the present invention have much better permeance than comparative gas separation membranes CGSM1, CGSM3 and CGSM4, even when a protective layer is present (see Example 3). GSM2 and Comparative CGSM2 were not tested because of the non-porous sheet.

1. A gas separation membrane comprising the following layers:
(i) optionally a support layer;
(ii) a discriminating layer;
(iii) a non gas separation selective further layer; and
(iv) a protective layer on top of the further layer (iii);
wherein:
(a) the further layer (iii) and the discriminating layer (ii) each independently comprise groups of Formula (1):
M-(O—)ₓ Formula (1)
wherein:
each M independently is a metal or metalloid atom;
O is an oxygen atom; and
each x independently has a value of at least 4;
(b) the further layer (iii) comprises 1.5 to 10 atomic % of M of Formula (1) groups, wherein M is as hereinbefore defined; and
(c) the discriminating layer (ii) comprises more than 10 atomic % of M of Formula (1) groups, wherein M is as hereinbefore defined.

2. The gas separation membrane according to claim 1 wherein the further layer (iii) is formed by a plasma deposition process using precursors in the absence of oxygen.

3. The gas separation membrane according to claim 1 wherein each M in Formula (1) in said discriminating layer or further layer (iii) independently is silicon, titanium, zirconium or aluminium.

4. The gas separation membrane according to claim 1 wherein the further layer (iii) has a thickness in the range 1 nm to 1,500 nm.

5. The gas separation membrane according to claim 1 wherein the further layer (iii) has a thickness in the range 5 nm to 1,000 nm.

6. The gas separation membrane according to claim 1 wherein the further layer (iii) comprises an average value for the atomic % of M of Formula (1) groups which is substantially constant throughout its depth.

7. The gas separation membrane according to claim 1 comprising on top of the further layer (iii) a polysiloxane protective layer (iv).

8. A process for forming a gas separation membrane according to claim 1 which comprises the steps of:
(a) applying the discriminating layer (ii) to the support layer (i) by a plasma treatment process; and
(b) applying further layer (iii) to the discriminating layer (ii) (the DL) by a plasma treatment process; and optionally
(c) applying a protective layer (iv) to the further layer (iii).

9. The process according to claim 8 wherein step (b) is performed by a plasma treatment process in the presence of one or more of the following precursor compounds: tetraethyl orthosilicate, hexamethyldisiloxane, tetramethyl orthosilicate, 1,3,5,7-tetramethylcyclotetrasiloxane, octamethyl cyclotetrasiloxane, decamethylcyclopentasiloxane, dodecamethylcyclohexasiloxane, bis(triethoxysilyl)ethane, tetrapropylorthotitanate, titanium ethoxide, titanium tetraisopropoxide or zirconium tetra-tert-butoxide.

10. The process according to claim 8 wherein step (b) is performed in an atmosphere free from oxygen.

11. The process according to claim 8 wherein the support layer (i) is or comprises a non-porous sheet and the process further comprises the step of removing the non-porous sheet from the gas separation membrane.

12. A gas separation module comprising a gas separation membrane according to claim 1.

13. (canceled)

14. The process according to claim 8 wherein step (a) comprises applying the discriminating layer (ii) to the support layer (i) by a plasma treatment process in an atmosphere comprising oxygen and step (b) comprises applying the further layer (iii) to the discriminating layer (ii) by a plasma treatment process in an atmosphere free from oxygen and in the presence of one or more of the following precursor compounds: tetraethyl orthosilicate, hexamethyldisiloxane, tetramethyl orthosilicate, 1,3,5,7-tetramethylcyclotetrasiloxane, octamethyl cyclotetrasiloxane, decamethylcyclopentasiloxane, dodecamethylcyclohexasiloxane, bis(triethoxysilyl)ethane, tetrapropylorthotitanate, titanium ethoxide, titanium tetraisopropoxide or zirconium tetra-tert-butoxide.
